(19) United States
(12) Patent Application Publication
(10) Pub. No.: US 2026/0093401 A1
(43) Pub. Date: Apr. 2, 2026

(54) MEMORY MANAGEMENT METHOD AND STORAGE DEVICE

(71) Applicant: Hefei Kaimeng Technology Co., Ltd., Anhui (CN)

(72) Inventors: Yang Zhang, Anhui (CN); Wan Jun HONG, Anhui (CN); Xin WANG, Anhui (CN); Tsung-Lin Wu, Anhui (CN); Qiao ZHU, Anhui (CN); Chong PENG, Anhui (CN)

(73) Assignee: Hefei Kaimeng Technology Co., Ltd., Anhui (CN)

(21) Appl. No.: 19/268,967

(22) Filed: Jul. 14, 2025

(30) Foreign Application Priority Data
Sep. 29, 2024 (CN) 202411374120.8

(51) Int. Cl. G06F 3/06

(52) U.S. Cl. CPC G06F 3/0616; G06F 3/0647; G06F 3/0659; G06F 3/0679

(57) ABSTRACT

A memory management method and a storage device are provided. The method includes: according to erase count information, read count information, and valid count information corresponding to each entity unit, obtaining quantified evaluation information corresponding to each entity unit; determining a source unit from the plurality of entity units according to the quantified evaluation information; and performing data migration on valid data in the source unit. Therefore, both the execution performance of a garbage collection operation and the maintenance management performance of the storage device may be balanced, so that the service life of the storage device may be increased.

### CROSS-REFERENCE TO RELATED APPLICATION

This application claims the priority benefit of China application serial no. 202411374120.8, filed on Sep. 29, 2024. The entirety of the above-mentioned patent application is hereby incorporated by reference herein and made a part of this specification.

### BACKGROUND

### Technical Field

The disclosure relates to a storage technology field, and more particularly relates to a memory management method and a storage device.

### Description of Related Art

When a storage device leaves the factory, a portion of entity units (e.g., entity blocks) in the storage device may be configured as free entity units, so as to use these free entity units to store new data. However, after the storage device is used for a period of time, the total number of free entity units in the storage device may gradually decrease. Therefore, after the storage device is used for a period of time, in the storage device, valid data may be moved from source units to target units through garbage collection (GC) operations, and entity units belonging to the source units are erased, so new free entity units are released.

Generally, in a garbage collection operation, entity units storing relatively less valid data may be preferentially selected as source units from which to move valid data. However, in specific situations, using the storage amount of valid data purely as the basis for screening source units may increase the difficulty of subsequent maintenance of the storage device (for example, repeatedly executing garbage collection on a small portion of entity units), and may even shorten the service life of the storage device.

Therefore, how to balance the execution performance of the garbage collection operations and the maintenance management performance for storage devices is a problem that urgently needs to be solved at present.

### SUMMARY

The disclosure provides a memory management method and a storage device capable of balancing the execution performance of a garbage collection operation and the maintenance management performance of the storage device, so that the service life of the storage device is increased.

An embodiment of the disclosure provides a memory management method for a storage device. The storage device includes a memory module including a plurality of entity units, and the memory management method includes the following steps. According to erase count information, read count information, and valid count information corresponding to each entity unit of the plurality of entity units, quantified evaluation information corresponding to each entity unit is obtained. A source unit from the plurality of entity units is determined according to the quantified evaluation information. Data migration is performed on valid data in the source unit.

An embodiment of the disclosure further provides a storage device including a connection interface, a memory module, and a memory controller. The connection interface unit is configured to be connected to a host system. The memory controller is connected to the connection interface and the memory module. The memory module includes a plurality of entity units, and the memory controller is configured to according to erase count information, read count information, and valid count information corresponding to each entity unit of the plurality of entity units, obtain quantified evaluation information corresponding to each entity unit, determine a source unit from the plurality of entity units according to the quantified evaluation information, and perform data migration on valid data in the source unit.

To sum up, according to the erase count information, the read count information, and the valid count information corresponding to each entity unit in the memory module, the quantified evaluation information corresponding to each entity unit may be obtained. According to the quantified evaluation information, the source unit may be determined from the entity units in the memory module, and then data migration is performed on the valid data in the source unit. That is, by comprehensively considering multiple types of information (such as the erase count information, the read count information, and the valid count information) beneficial for maintenance and management of the storage device to select the source unit, both the execution performance of a garbage collection operation and the maintenance and management performance of the storage device are balanced, and that the service life of the storage device is increased.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view illustrating a data storage system according to an embodiment of the disclosure.

FIG. 2 is a schematic view illustrating a memory controller according to an embodiment of the disclosure.

FIG. 3 is a schematic view illustrating management of a memory module according to an embodiment of the disclosure.

FIG. 4 is a schematic view illustrating a data organization operation according to an embodiment of the disclosure.

FIG. 5 is a schematic view illustrating obtaining quantified evaluation information according to an embodiment of the disclosure.

FIG. 6 is a schematic view illustrating determining a source unit according to quantified evaluation information corresponding to a plurality of entity units according to an embodiment of the disclosure.

FIG. 7 is a flow chart illustrating a memory management method according to an embodiment of the disclosure.

### DESCRIPTION OF THE EMBODIMENTS

Descriptions of the disclosure are given with reference to the exemplary embodiments illustrated by the accompanying drawings. Wherever possible, the same reference numbers are used in the drawings and the description to refer to the same or like parts.

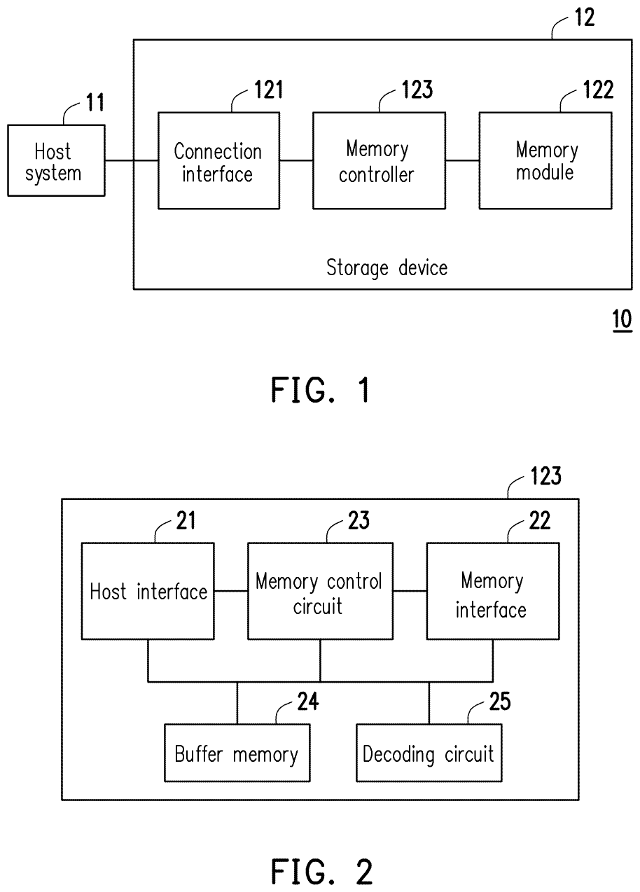

FIG. 1 is a schematic view illustrating a data storage system according to an embodiment of the disclosure. Referring to FIG. 1, a data storage system 10 includes a host system 11 and a storage device 12. The storage device 12 may be connected to the host system 11 and may be used to store data from the host system 11. For instance, the host system 11 may be a smartphone, a tablet computer, a notebook computer, a desktop computer, an industrial computer, a gaming console, a server, or a computer system disposed in a specific carrier (e.g., a vehicle, an aircraft, or a ship), and a type of the host system 11 is not limited thereto. In addition, the storage device 12 may include a solid-state drive, a USB flash drive, a memory card, or other types of non-volatile storage devices.

The storage device 12 includes a connection interface 121, a memory module 122, and a memory controller 123. The connection interface 121 is used to connect the storage device 12 to the host system 11. For instance, the connection interface 121 may support the embedded multi-media card (eMMC), universal flash storage (UFS), peripheral component interconnect express (PCI Express), non-volatile memory express (NVM express), serial advanced technology attachment (SATA), universal serial bus (USB), or other types of connection interface standards. Therefore, the storage device 12 may communicate (e.g., exchange signals, instructions, and/or data) with the host system 11 via the connection interface 121.

The memory module 122 is used to store data. For instance, the memory module 122 may include one or more rewritable non-volatile memory modules. Each rewritable non-volatile memory module may include one or more storage unit arrays. Storage units in the storage unit arrays store data in the form of voltage (also referred to as threshold voltage). For instance, the memory module 122 may include a single level cell (SLC) NAND flash memory module, a multi level cell (MLC) NAND flash memory module, a triple level cell (TLC) NAND flash memory module, a quad level cell (QLC) NAND flash memory module, and/or other memory modules having the same or similar characteristics.

The memory controller 123 is connected to the connection interface 121 and the memory module 122. The memory controller 123 may be treated as a control core of the storage device 12 and is used to control the storage device 12. For instance, the memory controller 123 may be used to control or manage the overall or partial operation of the storage device 12. For example, the memory controller 123 may include a central processing unit (CPU), or other programmable general-purpose or special-purpose microprocessor, digital signal processor (DSP), programmable controller, application specific integrated circuit (ASIC), programmable logic device (PLD), or other similar devices or combinations of these devices. In an embodiment, the memory controller 123 may include a flash memory controller.

The memory controller 123 may send an instruction sequence to the memory module 122 to access the memory module 122. For instance, the memory controller 123 may send a write instruction sequence to the memory module 122, so as to instruct the memory module 122 to store data in a specific storage unit. For instance, the memory controller 123 may send a read instruction sequence to the memory module 122, so as to instruct the memory module 122 to read data from a specific storage unit. For instance, the memory controller 123 may send an erase instruction sequence to the memory module 122, so as to instruct the memory module 122 to erase data stored in a specific storage unit. In addition, the memory controller 123 may also send other types of instruction sequences to the memory module 122, so as to instruct the memory module 122 to execute other types of operations, which is not particularly limited by the disclosure. The memory module 122 may receive an instruction sequence from the memory controller 123 and access a storage unit inside the memory module 122 according to the instruction sequence.

FIG. 2 is a schematic view illustrating a memory controller according to an embodiment of the disclosure. Referring to FIG. 1 and FIG. 2, the memory controller 123 includes a host interface 21, a memory interface 22, and a memory control circuit 23. The host interface 21 is configured to be connected to the host system 11 through the connection interface 121 to communicate with the host system 11. The memory interface 22 is configured to be connected to the memory module 122 to access the memory module 122.

The memory control circuit 23 is connected to the host interface 21 and the memory interface 22. The memory control circuit 23 may be used to control or manage the overall or partial operation of the memory controller 123. For instance, the memory control circuit 23 may communicate with the host system 11 through the host interface 21 and access the memory module 122 through the memory interface 22. For instance, the memory control circuit 23 may include control circuits such as an embedded controller or a microcontroller. In the following embodiments, the description of the memory control circuit 23 is equivalent to the description of the memory controller 123.

In an embodiment, the memory controller 123 may further include a buffer memory 24. The buffer memory 24 is connected to the memory control circuit 23 and is used to buffer data. For instance, the buffer memory 24 may be used to buffer an instruction from the host system 11, data from the host system 11, and/or data from the memory module 122.

In an embodiment, the memory controller 123 may further include a decoding circuit 25. The decoding circuit 25 is connected to the memory control circuit 23 and is used to execute encoding and decoding on data to ensure correctness of the data. For instance, the decoding circuit 25 may support various encoding/decoding algorithms such as the low density parity check code (LDPC code), BCH code, Reed-solomon code (RS code), exclusive OR (XOR) code, and the like. In an embodiment, the memory controller 123 may further include other types of various circuit modules (e.g., a power management circuit, etc.), which is not particularly limited by the disclosure.

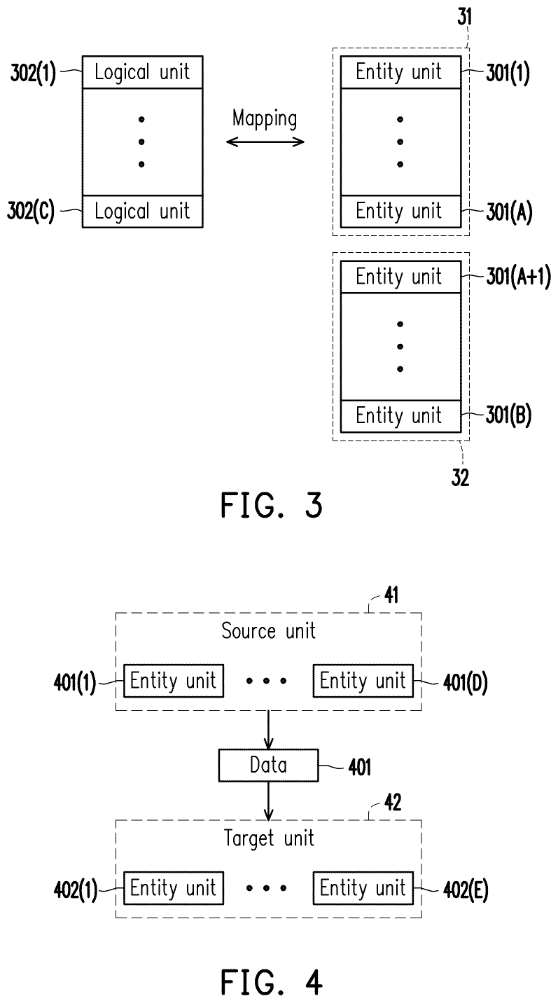

FIG. 3 is a schematic view illustrating management of a memory module according to an embodiment of the disclosure. Referring to FIG. 1 to FIG. 3, the memory module 122 includes a plurality of entity units 301(1) to 301(B). Each entity unit includes a plurality of storage units and is used to non-volatilely store data.

In an embodiment, one entity unit may include one or a plurality of entity erase units. In addition, one entity unit may include a plurality of sub-entity units. For instance, one sub-entity unit may include one or a plurality of entity programming units. In an embodiment, one entity unit may include one or a plurality of virtual blocks. Each virtual block may include multiple entity erase units.

In an embodiment, one entity programming unit may include a plurality of entity sectors. For instance, a data capacity of one entity sector may be 512 bytes(B), and one entity programming unit may include 32 entity sectors. However, the data capacity of one entity sector and/or the total number of entity sectors included in one entity programming unit may be adjusted according to practical needs, which is not particularly limited by the disclosure. In an embodiment, an entity programming unit may be treated as an entity page. For instance, the storage capacity of one entity programming unit may be 16 kilobytes, and the disclosure is not limited thereto.

In an embodiment, one entity programming unit is a minimum unit for synchronously writing data in the memory module 122. For instance, when performing a programming operation (also referred to as a write operation) on one entity programming unit to write data to the entity programming unit, multiple storage units in the entity programming unit may be synchronously programmed to store corresponding data. For instance, when programming one entity programming unit, a write voltage may be applied to the entity programming unit, so as to change threshold voltages of at least some storage units in the entity programming unit. For instance, the threshold voltage of one storage unit may reflect bit data stored by the storage unit.

In one embodiment, one entity erase unit may include multiple entity programming units. Multiple entity programming units in one entity erase unit may be synchronously erased. For instance, when performing an erase operation on one entity erase unit, an erase voltage may be applied to the multiple entity programming units in this entity erase unit, so as to change the threshold voltages of at least some storage units in these entity programming units. By performing an erase operation on one entity erase unit, data stored in this entity erase unit may be cleared.

In an embodiment, the memory control circuit 23 may logically associate the entity units 301(1) to 301(A) and 301(A+1) to 301(B) to a data area 31 and a free area 32, respectively. The entity units 301(1) to 301(A) in the data area 31 all store data (also referred to as user data) from the host system 11. For instance, any entity unit in the data area 31 may store valid data and/or invalid data. In addition, the entity units 301(A+1) to 301(B) in the free area 32 do not store data (e.g., valid data).

In an embodiment, if a specific entity unit does not store valid data, this entity unit may be associated with the free area 32. In addition, the entity unit in the free area 32 may be erased to clear the data in this entity unit. In an embodiment, the entity unit in the free area 32 is also referred to as a free entity unit. In an embodiment, the free area 32 is also referred to as a free pool.

In an embodiment, when data is to be stored, the memory control circuit 23 may select one or more entity units from the free area 32 and instruct the memory module 122 to store the data in the selected entity unit. After storing the data in the entity unit, the entity unit may be associated with the data area 31. In other words, one or more entity units may be alternately used between the data area 31 and the free area 32.

In an embodiment, the memory control circuit 23 may be provided with a plurality of logical units 302(1) to 302(C) to map entity units (i.e., entity units 301(1) to 301(A)) in the data area 31. For instance, one logical unit may correspond to one logical block address (LBA) or other logical management units. One logical unit may map to one or more entity units.

In an embodiment, if a specific entity unit is currently mapped by any logical unit, the memory control circuit 23 may determine that the data currently stored in this entity unit includes valid data. Conversely, if a specific entity unit is currently not mapped by any logical unit, the memory control circuit 23 may determine that this entity unit currently does not store any valid data.

In an embodiment, the memory control circuit 23 may record a mapping relationship between logical units and entity units in at least one management table (also referred to as a logical-to-entity mapping table). In an embodiment, the memory control circuit 23 may instruct the memory module 122 to execute operations such as data read, write, or erase according to information in this management table (i.e., the logical-to-entity mapping table).

In an embodiment, the memory control circuit 23 may monitor the total number of entity units in the current free area 32 (i.e., free entity units, such as the entity units 301(A+1) to 301(B)). The memory control circuit 23 may determine whether the total number of entity units in the free area 32 is less than a threshold value (also referred to as a first threshold value). If the total number of entity units in the free area 32 is less than the first threshold value, the memory control circuit 23 may initiate or trigger a data organization operation. For instance, the data organization operation is used to release new free entity units to increase the total number of free entity units. For instance, the data organization operation may include a garbage collection (GC) operation or similar operations.

In an embodiment, in a data organization operation, the memory control circuit 23 may select at least one entity unit from the data area 31 as a source unit. For instance, the memory control circuit 23 may select at least one entity unit from the entity units 301(1) to 301(A) in the data area 31 as a source unit. In addition, in the data organization operation, the memory control circuit 23 may select at least one entity unit from the free area 32 as a target unit. For instance, the memory control circuit 23 may select at least one entity unit from the entity units 301(A+1) to 301(B) in the free area 32 as a source unit.

In the data organization operation, after the source unit is determined, the memory control circuit 23 may instruct the memory module 122 to move or copy valid data from the source unit to the target unit. If the valid data in a specific entity unit serving as the source unit has been completely moved or copied to the target unit, the memory control circuit 23 may associate this entity unit with the free area 32 and may instruct the memory module 122 to erase this entity unit. In this way, the purpose of releasing new free entity units may be achieved to increase the total number of free entity units.

FIG. 4 is a schematic view illustrating a data organization operation according to an embodiment of the disclosure. Referring to FIG. 4, in an embodiment, the memory control circuit 23 may determine entity units 401(1) to 401(D) as a source unit 41 and determine entity units 402(1) to 402(E) as a target unit 42. In the data organization operation, the memory control circuit 23 may instruct the memory module 122 to read data 401 (i.e., valid data) from the source unit 41 (i.e., the entity units 401(1) to 401(D)) and store the read data 401 in a concentrated manner to the target unit 42 (i.e., the entity units 402(1) to 402(E)). Further, if the valid data in an entity unit 401(i) has been completely moved or copied to the target unit 42, the memory control circuit 23 may associate the entity unit 401(i) to the free area 32 and may instruct the memory module 122 to erase the entity unit 401(i).

In an embodiment, after the data organization operation is started or triggered, the memory control circuit 23 may determine whether the total number of entity units in the free area 32 is greater than a threshold value (also referred to as a second threshold value). If the total number of entity units in the free area 32 is greater than the second threshold value, the memory control circuit 23 may stop the data organization operation. It should be noted that, in an embodiment, the data organization operation may also be started (or triggered) and/or stopped according to other conditions, which is not particularly limited by the disclosure.

In an embodiment, the memory control circuit 23 may obtain erase count information, read count information, and valid count information corresponding to each entity unit among the plurality of entity units in the memory module 122. Taking an entity unit 301(i) (also referred to as a first entity unit) in FIG. 3 as an example, the erase count information corresponding to the entity unit 301(i) (also referred to as first erase count information) may reflect the total count of erase operations executed on the entity unit 301(i). The read count information (also referred to as first read count information) corresponding to the entity unit 301(i) may reflect the total count of read operations executed on the entity unit 301(i). In addition, first valid count information corresponding to the entity unit 301(i) reflects a total data amount of valid data stored in the entity unit 301(i).

In an embodiment, the erase operation executed on the entity unit 301(i) is used to erase data stored in the entity unit 301(i). In an embodiment, each time an erase operation is executed on the entity unit 301(i), the memory control circuit 23 may update the erase count information corresponding to the entity unit 301(i) (i.e., the first erase count information), for example, adding “1” to the first erase count information.

In an embodiment, the read operation executed on the entity unit 301(i) is used to read data from the entity unit 301(i). In an embodiment, each time a read operation is executed on the entity unit 301(i), memory control circuit 23 may update the read count information (i.e., the first read count information) corresponding to the entity unit 301(i), for example, adding “1” to the first read count information.

In an embodiment, the total data amount of valid data stored in the entity unit 301(i) may be represented by the total number of sub-entity units (i.e., the entity programming units) currently storing valid data in the entity unit 301(i). For instance, assuming that the valid count information (i.e., the first valid count information) corresponding to the entity unit 301(i) is “20”, it indicates that currently 20 sub-entity units (i.e., the entity programming units) in the entity unit 301(i) store valid data

In an embodiment, the memory control circuit 23 may obtain quantified evaluation information corresponding to the entity unit 301(i) according to the erase count information, the read count information, and the valid count information corresponding to the entity unit 301(i). It should be noted that in the following embodiments, the entity unit 301(i) is used to represent any entity unit in the memory module 122 to illustrate how to obtain the corresponding quantified evaluation information.

In an embodiment, according to the quantified evaluation information corresponding to each entity unit, the memory control circuit 23 may determine the source unit from the multiple entity units. For instance, the memory control circuit 23 may determine at least one entity unit corresponding to the maximum or relatively large quantified evaluation information among the entity units as the source unit. Next, in the data organization operation, the memory control circuit 23 may perform data movement on the valid data in the source unit. The operational details regarding the data organization operation may refer to the embodiments of FIG. 4, and description thereof is not repeated herein.

In an embodiment, the memory control circuit 23 may read a plurality of control information from one management table. Next, the memory control circuit 23 may obtain the quantified evaluation information corresponding to the entity unit 301(i) according to the plurality of control information and the erase count information, the read count information, and the valid count information corresponding to the entity unit 301(i).

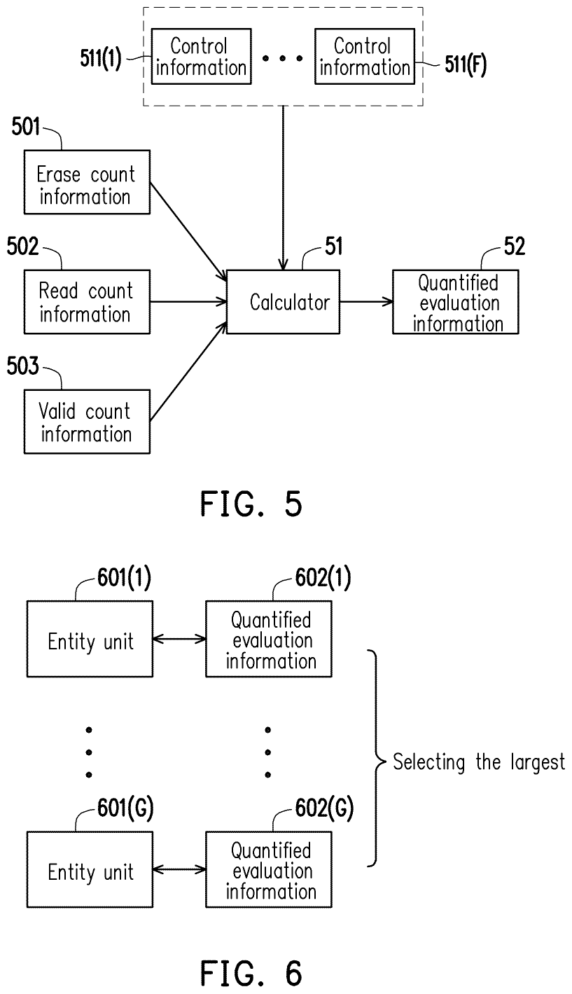

FIG. 5 is a schematic view illustrating obtaining quantified evaluation information according to an embodiment of the disclosure. Referring to FIG. 5, in an embodiment, the memory control circuit 23 may obtain erase count information 501, read count information 502, and valid count information 503. The erase count information 501 may reflect the total count of erase operations executed on the entity unit 301(i). The read count information 502 may reflect the total count of read operations executed on the entity unit 301(i). The valid count information 503 may reflect the total data amount of valid data stored in the entity unit 301(i). In addition, the memory control circuit 23 may read control information 511(1) to 511(F) from a management table.

In an embodiment, the memory control circuit 23 may operate a calculator 51. For instance, the calculator 51 may be implemented through software, firmware, or hardware. In an embodiment, the memory control circuit 23 may input the erase count information 501, the read count information 502, the valid count information 503, and the control information 511(1) to 511(F) to the calculator 51. The calculator 51 may generate quantified evaluation information 52 corresponding to the entity unit 301(i) according to the erase count information 501, the read count information 502, the valid count information 503, and the control information 511(1) to 511(F).

In an embodiment, the control information 511(1) to 511(F) include weight control information. The weight control information may be used to adjust a calculation weight of at least one of the erase count information 501, the read count information 502, and the valid count information 503 on the quantified evaluation information 52. For instance, the control information 511(1) may include weight control information We(i) corresponding to the erase count information 501, control information 511(2) may include weight control information Wr(i) corresponding to the read count information 502, and control information 511(3) may include weight control information Wp(i) corresponding to the valid count information 503. The weight control information We(i) is used to adjust the calculation weight of the erase count information 501 on the quantified evaluation information 52. The weight control information Wr(i) is used to adjust the calculation weight of the read count information 502 on the quantified evaluation information 52. The weight control information Wp(i) is used to adjust the calculation weight of the valid count information 503 on the quantified evaluation information 52.

In an embodiment, the memory control circuit 23 may obtain the quantified evaluation information corresponding to the entity unit 301(i) according to the following formula (1).

$$S ( i ) = We ( i ) \times E ( i ) + Wr ( i ) \times R ( i ) + Wp ( i ) \times P ( i ) \qquad ( 1 )$$

In formula (1), S(i) represents the quantified evaluation information (e.g., the quantified evaluation information 52 of FIG. 5) corresponding to the entity unit 301(i), E(i) represents the erase count information (e.g., the erase count information 501 of FIG. 5) corresponding to the entity unit 301(i), R(i) represents the read count information (e.g., the read count information 502 of FIG. 5) corresponding to the entity unit 301(i), P(i) represents the valid count information (e.g., the valid count information 503 of FIG. 5) corresponding to the entity unit 301(i). In addition, We(i), Wr(i), and Wp(i) are weight control information (e.g., the control information 511(1), 522(2), and 511(3) of FIG. 5) corresponding to E(i), R(i), and P(i) respectively. It should be noted that formula (1) may be adjusted according to practical needs, which is not particularly limited by the disclosure.

In an embodiment, We(i), Wr(i), and Wp(i) may be values between “O” and “1”, and a sum of W1(i), W2(i), and W3(i) may be “1”. For instance, in an embodiment, We(i), Wr(i), and Wp(i) may respectively be “0.3”, “0.4”, and “0.3”. It should be noted that We(i), Wr(i), and Wp(i) may be adjusted according to practical needs, which is not particularly limited by the disclosure.

In an embodiment, the memory control circuit 23 may adjust at least one of We(i), Wr(i), and Wp(i) (i.e., at least one of the control information 511(1) to 511(F) in FIG. 5) to regulate the influence (i.e., the calculation weight) of at least one of the erase count information 501, the read count information 502, and the valid count information 503 on the quantitative evaluation information 52. For instance, by increasing We(i), the memory control circuit 23 may increase the influence (i.e., the calculation weight) of the erase count information 501 on the quantitative evaluation information 52. Alternatively, by increasing Wr(i), the memory control circuit 23 may increase the influence (i.e., the calculation weight) of the read count information 502 on the quantitative evaluation information 52. Alternatively, by increasing Wp(i), the memory control circuit 23 may increase the influence (i.e., the calculation weight) of the valid count information 503 on the quantitative evaluation information 52.

In other words, the memory control circuit 23 may dynamically adjust at least one of We(i), Wr(i), and Wp(i) (i.e., at least one of the control information 511(1) to 511(F) in FIG. 5) under the premise of ensuring that the sum of W1(i), W2(i), and W3(i) is “1” to satisfy current needs. For instance, in a case where the influence of the erase count on the memory module 122 is more emphasized, the memory control circuit 23 may increase We(i). Accordingly, during subsequent execution of data organization operations, the memory control circuit 23 may increase the influence that the erase count has on maintenance of the memory module 122, so that the execution performance of data organization operations and the maintenance management performance are balanced for the storage device 12.

In an embodiment, the memory control circuit 23 may perform a normalization operation (also referred to as a regularization operation) on the erase count information, the read count information, and the valid count information corresponding to the entity unit 301(i) according to the multiple control information. Taking FIG. 5 as an example, the control information 511(1) to 511(F) may include maximum erase count information, minimum erase count information, maximum read count information, minimum read count information, maximum valid count information, and minimum valid count information. The memory control circuit 23 may execute the normalization operation on the erase count information 501, the read count information 502, and the valid count information 503 according to the control information 511(1) to 511(F). The erase count information, the read count information, and the valid count information after the normalization operation may synchronously fall into a predetermined numerical range (also referred to as a target numerical range). In an embodiment, through the normalization operation, the efficiency of comprehensive evaluation for management information of different scales (i.e., the erase count information, the read count information, and the valid count information) may be improved.

In an embodiment, the memory control circuit 23 may perform normalization operations on the erase count information, the read count information, and the valid count information corresponding to the entity unit 301(i) according to the following formulas (2.1) to (2.3).

$$E ( i ) ’ = ( E ( i ) - Emin ) / ( Emax - Emin ) \qquad ( 2.1 )$$

$$R ( i ) ’ = ( R ( i ) - Rmin ) / ( Rmax - Rmin ) \qquad ( 2.2 )$$

$$P ( i ) ’ = ( P ( i ) - Pmin ) / ( Pmax - Pmin ) \qquad ( 2.3 )$$

In formulas (2.1) to (2.3), E(i)′, R(i)′, and P(i)′ respectively represent normalized E(i), R(i), and P(i). In addition, Emax represents the maximum erase count information, Emin represents the minimum erase count information, Rmax represents the maximum read count information, Rmin represents the minimum read count information, Pmax represents the maximum valid count information, and Pmin represents the minimum valid count information. In an embodiment, E(i)′, R(i)′, and P(i)′ may respectively replace E(i), R(i), and P(i) and be substituted into the aforementioned formula (1) to obtain the quantified evaluation information corresponding to the entity unit 301(i). It should be noted that formulas (2.1) to (2.3) may be adjusted according to practical needs, which is not particularly limited by the disclosure.

In an embodiment, the memory control circuit 23 may adopt a polynomial function to calculate the quantified evaluation information corresponding to the entity unit 301(i). For instance, the memory control circuit 23 may obtain the quantified evaluation information corresponding to the entity unit 301(i) according to the following formula (3).

S(i)=We(i)×E(i)²+Wr(i)×R(i)²+Wp(i)×P(i)² (3)

It should be noted that in an embodiment, if Formula 3 (i.e., the polynomial function) is used to calculate the quantified evaluation information corresponding to the entity unit 301(i), then We(i), Wr(i), and Wp(i) may all be set to “1”. Therefore, through parameter amplification, the beneficial technical effect of ensuring that management information of different scales (i.e., the erase count information, the read count information, and the valid count information) are comprehensively evaluated under almost the same scale may be achieved. However, in an embodiment, We(i), Wr(i), and Wp(i) used in Formula 3 may also be set according to practical needs, which is not particularly limited by the disclosure. It should be noted that formula (3) may be adjusted according to practical needs, which is not particularly limited by the disclosure.

In an embodiment, the memory control circuit 23 may determine the management table from a plurality of candidate management tables according to system information. For instance, the system information may include a numerical value. This numerical value may change according to current needs. Different numerical values may point to different candidate management tables. Each candidate management table may record a control information combination. Different candidate management tables may record different control information combinations. For instance, the candidate management tables may include a first candidate management table and a second candidate management table. The first candidate management table may record a first control information combination. The second candidate management table may record a second control information combination. The first control information combination may be different from the second control information combination. After the management table is determined, the memory control circuit 23 may read the multiple control information (e.g., the control information 511(1) to 511(F) of FIG. 5) from the management table. For instance, the control information 511(1) to 511(F) obtained from the first candidate management table may be at least partially different from the control information 511(1) to 511(F) obtained from the second candidate management table. Therefore, the memory control circuit 23 may automatically select the most suitable control information combination according to current needs.

FIG. 6 is a schematic view illustrating determining a source unit according to quantified evaluation information corresponding to a plurality of entity units according to an embodiment of the disclosure. Referring to FIG. 6, in an embodiment, the memory control circuit 23 may determine quantified evaluation information 602(1) to 602(G) respectively corresponding to entity units 601(1) to 601(G). For operational details regarding how to obtain the quantified evaluation information, reference may be made to the embodiments of FIG. 5, and description thereof is not repeated herein.

In an embodiment, the memory control circuit 23 may determine at least one of the entity units 601(1) to 601(G) as a source unit according to the quantified evaluation information 602(1) to 602(G). For instance, the memory control circuit 23 may compare the quantified evaluation information 602(1) to 602(G) to obtain a comparison result. This comparison result may reflect a quantitative relationship among the quantified evaluation information 602(1) to 602(G). Next, the memory control circuit 23 may determine at least one entity unit corresponding to the maximum or relatively large quantified evaluation information among the entity units 601(1) to 601(G) as the source unit according to this comparison result. Subsequently, in a data organization operation, the memory control circuit 23 may perform data movement on the valid data in the source unit. The operational details regarding the data organization operation may refer to the embodiments of FIG. 4, and description thereof is not repeated herein. In an embodiment, according to the quantified evaluation information 602(1) to 602(G), the memory control circuit 23 may also adopt other selection mechanisms to determine the source unit from the entity units 601(1) to 601(G), which is not particularly limited by the disclosure

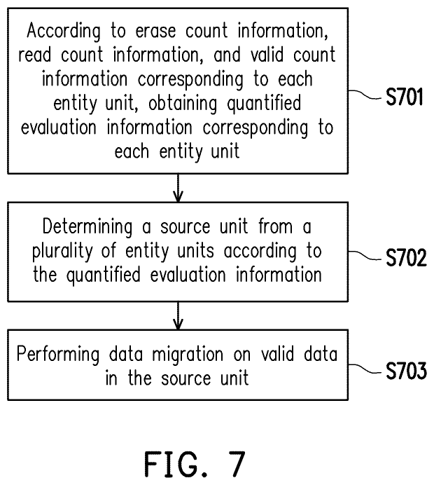

FIG. 7 is a flow chart illustrating a memory management method according to an embodiment of the disclosure. Referring to FIG. 7, in step S701, according to erase count information, read count information, and valid count information corresponding to each entity unit among a plurality of entity units, quantified evaluation information corresponding to each entity unit is obtained. In step S702, according to the quantified evaluation information, a source unit is determined from the entity units. In step S703, data movement is executed on valid data in the source unit.

However, each step of FIG. 7 has been described in detail in the foregoing paragraphs, and description thereof is thus not repeated herein. It should be noted that each step of FIG. 7 may be implemented as a plurality of program codes or circuits, which is not particularly limited by the disclosure. In addition, the method of FIG. 7 may be used in combination with the above-described exemplary embodiments or may be used solely, which is not particularly limited by the disclosure.

In view of the foregoing, in the memory management method and the storage device provided by the embodiments of the disclosure, the source unit for data organization operations may be selected based on multiple types (and multiple scales) of the management information (i.e., the erase count information, the read count information, and the valid count information). In particular, through specially designed and/or dynamically selected control information, the calculation weights corresponding to different types of management information may be dynamically adjusted according to current needs, and/or the management information of different scales may be fused and calculated according to current needs. Therefore, both the execution performance of garbage collection operations and the maintenance management performance of the storage device may be balanced, so that the service life of the storage device may be increased.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A memory management method for a storage device, wherein the storage device comprises a memory module comprising a plurality of entity units, and the memory management method comprises:
according to erase count information, read count information, and valid count information corresponding to each entity unit of the plurality of entity units, obtaining quantified evaluation information corresponding to each entity unit;
determining a source unit from the plurality of entity units according to the quantified evaluation information; and
performing data migration on valid data in the source unit.

2. The memory management method according to claim 1, wherein the plurality of entity units comprise a first entity unit, first erase count information corresponding to the first entity unit reflects a total count of erase operations executed on the first entity unit, first read count information corresponding to the first entity unit reflects a total count of read operations executed on the first entity unit, and first valid count information corresponding to the first entity unit reflects a total data amount of valid data stored in the first entity unit.

3. The memory management method according to claim 1, wherein the step of according to the erase count information, the read count information, and the valid count information corresponding to each entity unit of the plurality of entity units, obtaining the quantified evaluation information corresponding to each entity unit comprises:
reading a plurality of control information from a management table; and
according to the plurality of control information, the erase count information, the read count information, and the valid count information, obtaining the quantified evaluation information corresponding to each entity unit.

4. The memory management method according to claim 3, wherein the plurality of control information comprises weight control information used to adjust a calculation weights of at least one of the erase count information, the read count information, and the valid count information for the quantified evaluation information.

5. The memory management method according to claim 3, wherein the step of according to the plurality of control information, the erase count information, the read count information, and the valid count information, obtaining the quantified evaluation information corresponding to each entity unit comprises:
according to the plurality of control information, executing a normalization operation on the erase count information, the read count information, and the valid count information, so that the normalized erase count information, read count information, and valid count information fall within a target numerical range.

6. The memory management method according to claim 5, wherein the plurality of control information comprises maximum erase count information, minimum erase count information, maximum read count information, minimum read count information, maximum valid count information, and minimum valid count information.

7. The memory management method according to claim 3, wherein the step of reading the plurality of control information from the management table comprises:
determining the management table from a plurality of candidate management tables according to system information,
wherein the plurality of candidate management tables comprise a first candidate management table and a second candidate management table, the first candidate management table records a first control information combination, and the second candidate management table records a second control information combination.

8. A storage device, comprising:
a connection interface configured to be connected to a host system;
a memory module; and
a memory controller connected to the connection interface and the memory module,
wherein the memory module comprises a plurality of entity units, and the memory controller is configured to:
according to erase count information, read count information, and valid count information corresponding to each entity unit of the plurality of entity units, obtain quantified evaluation information corresponding to each entity unit,
determine a source unit from the plurality of entity units according to the quantified evaluation information, and
perform data migration on valid data in the source unit.

9. The storage device according to claim 8, wherein the plurality of entity units comprise a first entity unit, first erase count information corresponding to the first entity unit reflects a total count of erase operations executed on the first entity unit, first read count information corresponding to the first entity unit reflects a total count of read operations executed on the first entity unit, and first valid count information corresponding to the first entity unit reflects a total data amount of valid data stored in the first entity unit.

10. The storage device according to claim 8, wherein the step of according to the erase count information, the read count information, and the valid count information corresponding to each entity unit of the plurality of entity units, obtaining the quantified evaluation information corresponding to each entity unit comprises:
read a plurality of control information from a management table; and
according to the plurality of control information, the erase count information, the read count information, and the valid count information, obtain the quantified evaluation information corresponding to each entity unit.

11. The storage device according to claim 10, wherein the plurality of control information comprises weight control information used to adjust a calculation weights of at least one of the erase count information, the read count information, and the valid count information for the quantified evaluation information.

12. The storage device according to claim 10, wherein the step of according to the plurality of control information, the erase count information, the read count information, and the valid count information, obtaining the quantified evaluation information corresponding to each entity unit comprises:
according to the plurality of control information, execute a normalization operation on the erase count information, the read count information, and the valid count information, so that the normalized erase count information, read count information, and valid count information fall within a target numerical range.

13. The storage device according to claim 12, wherein the plurality of control information comprises maximum erase count information, minimum erase count information, maximum read count information, minimum read count information, maximum valid count information, and minimum valid count information.

14. The storage device according to claim 10, wherein the step of reading the plurality of control information from the management table comprises:
determine the management table from a plurality of candidate management tables according to system information,
wherein the plurality of candidate management tables comprise a first candidate management table and a second candidate management table, the first candidate management table records a first control information combination, and the second candidate management table records a second control information combination.
